(19) United States
(12) Patent Application Publication
(10) Pub. No.: US 2023/0077688 A1
(43) Pub. Date: Mar. 16, 2023

(54) DETERMINER, PRINTER, DETERMINATION METHOD AND STORAGE MEDIUM

(71) Applicant: CASIO COMPUTER CO., LTD., Tokyo (JP)

(72) Inventor: Masaya NAKAZAWA, Tokyo (JP)

(21) Appl. No.: 17/940,651

(22) Filed: Sep. 8, 2022

(30) Foreign Application Priority Data
Sep. 10, 2021 (JP) 2021-147999

(51) Int. Cl. G06V 40/10; A45D 29/00; B41J 3/407

(52) U.S. Cl. CPC G06V 40/11; A45D 29/00; B41J 3/407; A45D 2029/005

(57) ABSTRACT

A determiner includes a memory and at least one processor. In the memory, a program is stored. The processor executes the program stored in the memory, and obtains an image of a hand including at least a first finger placed on a placement surface, and determines a type of the first finger based on a placement state of second fingers recognized as fingers in the image.

### CROSS-REFERENCE TO RELATED APPLICATIONS

This application is based upon and claims the benefit of priority from Japanese Patent Application No. 2021-147999 filed on Sep. 10, 2021, the entire content of which, including the specification, claims and drawings, is incorporated herein by reference.

### BACKGROUND

### Technical Field

The present disclosure relates to a determiner, a printer, a determination method and a storage medium.

### Description of Related Art

There has been known a printer (nail printer) that prints designs on nails or the like.

With this type of printer, a user can enjoy printing various designs on nails or the like easily, without manually applying nail polish thereto. (See, for example, JP 2000-194838 A.)

### SUMMARY

A determiner includes:

a memory where a program is stored; and

at least one processor that executes the program stored in the memory, wherein the processor
obtains an image of a hand including at least a first finger placed on a placement surface, and
determines a type of the first finger based on a placement state of second fingers recognized as fingers in the image.

### BRIEF DESCRIPTION OF DRAWINGS

The accompanying drawings, which are incorporated in and constitute a part of the specification, illustrate embodiments, and together with the general description given above and the detailed description of the embodiments given below, serve to explain the principles of the present disclosure, wherein:

FIG. 1 is a perspective view of the main part of a printer according to an embodiment(s), showing its external configuration;

FIG. 2 is a block diagram of the main parts of the printer according to the embodiment and its cooperating terminal device, showing control configurations thereof;

FIG. 3A is a plan view showing a state in which the middle finger of a left hand is placed on a finger rest;

FIG. 3B is a plan view showing a state in which the ring finger of a right hand is placed on the finger rest;

FIG. 4 is a plan view showing a state in which the thumb of a left hand is placed on the finger rest;

FIG. 5 shows an example of a determination table of the embodiment;

FIG. 6 is a flowchart showing the overall flow of a printing control process of the embodiment;

FIG. 7 is a flowchart showing details of a determination process for four fingers shown in FIG. 6;

FIG. 8 is a flowchart showing details of a determination process for thumbs shown in FIG. 6; and

FIG. 9 is a plan view showing a state in which the thumb of a left hand is placed on the finger rest according to a modification.

### DETAILED DESCRIPTION

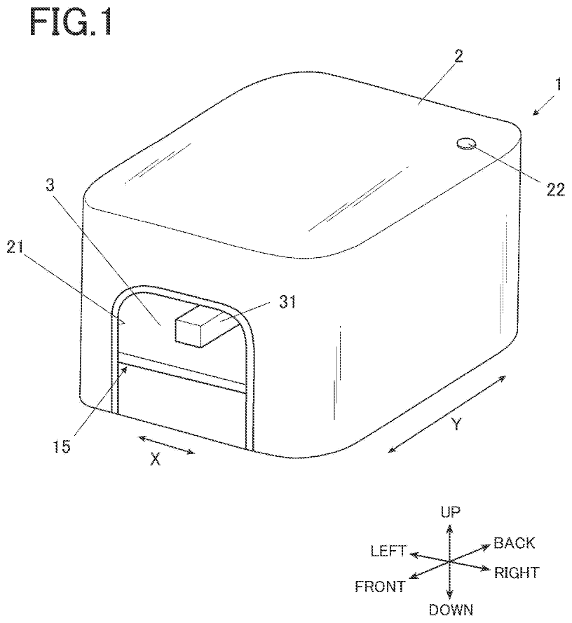

With reference to FIG. 1 through FIG. 8, one or more embodiments of a printer including a determiner, a determination method and a storage medium storing a program(s) according to the present disclosure will be described.

Although various limitations technically preferable for carrying out the present disclosure are put on embodiments described below, the scope of the present disclosure is not limited to the embodiments below or illustrated examples.

Further, in the embodiments below, the determiner is applied, for example, to a printer that treats nails of fingers of hands as a printing target(s) on which the printer performs printing and treats the surfaces of the nails as a printing target surface(s) on which the printer performs printing. The determiner of the present disclosure is applicable to not only the printer of the embodiments below but also others. Further, the printing target of the printer is not only nails of fingers of hands but also others, such as nails of toes of feet.

FIG. 1 is a perspective view of the main part of a printer according to an embodiment(s), showing its external configuration.

In the embodiment(s) below, up and down, left and right, and front and back are those shown in FIG. 1, and also X and Y directions are those shown in FIG. 1.

As shown in FIG. 1, a printer 1 has a substantially box-shaped case 2.

In the front surface of the case 2 (front side of the printer 1, front side in FIG. 1), a wide opening 21 is formed at almost the center in the left-right direction (lateral direction of the printer 1, left-right direction or X direction in FIG. 1). In this embodiment, the opening 21 has a width and a height great enough for one whole hand to be put into and taken out from the printer 1.

On the upper surface (top panel), lateral surface or the like of the case 2, an operation unit 22 is provided. The operation unit 22 is a functional component for a user to make various inputs. In this embodiment, the operation unit 22 is provided on the upper surface of the case 2.

Examples of the operation unit 22 includes a power switch-button to power up the printer 1 and a stop switch-button to stop operation. When a user operates the operation unit 22, an instruction signal corresponding to the operation is output to a controller 11 described below.

FIG. 1 shows the operation unit 22 that is configured by a single button, but may be configured by a plurality of buttons and/or the like provided on the upper surface or the like of the case 2.

If the upper surface or the like of the case 2 is configured as a touchscreen, the touchscreen functions as the operation unit 22.

The printer 1 may be operated by input operations from an operation unit 83 of a terminal device 8 described below.

On the upper surface or the like of the case 2, a display, various lamps, indicators and so forth, which are all not shown, may be provided.

The inside of the case 2 is divided by a partition plate 15 into an upper section and a lower section.

The upper surface of the partition plate 15 is a placement surface 3 where a finger(s) U with a nail(s) T or one whole hand H inserted into the printer 1 through the opening 21 is placed.

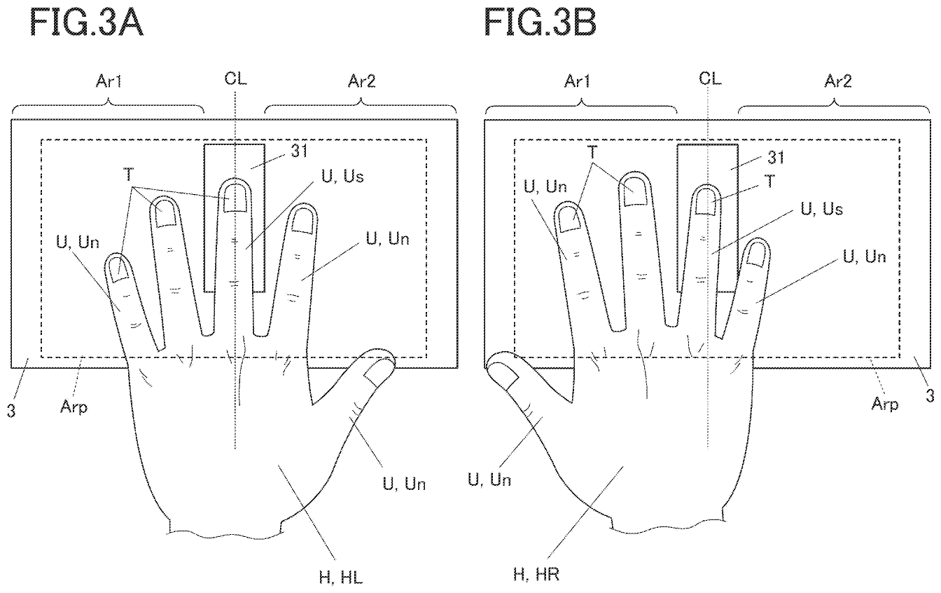

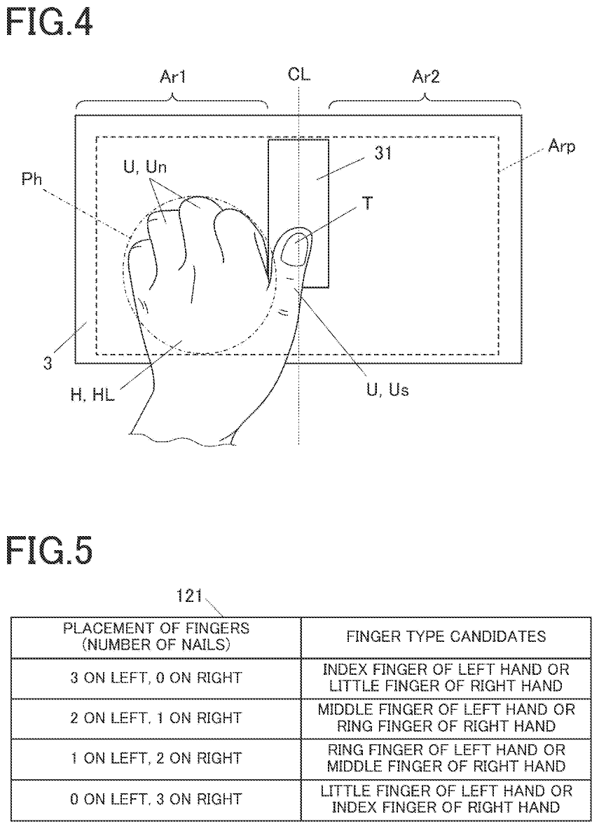

FIG. 3A, FIG. 3B and FIG. 4 are plan views each showing a state in which the hand H is placed on the placement surface 3.

As shown in FIG. 1, FIG. 3A, FIG. 3B and FIG. 4, at almost the center of the placement surface 3 in the width direction (X direction in FIG. 1), a finger rest 31 extending in the depth direction (Y direction in FIG. 1) is provided. As shown in FIG. 1, the finger rest 31 is one step higher than the placement surface 3.

In this embodiment, a finger Us, which corresponds to a nail T as the printing target, is placed on the finger rest 31. That is, the finger rest 31 is where a specific finger U, namely, the finger Us, corresponding to the nail T as the printing target, is placed. Although not shown, it is preferable that the finger rest 31 is provided with a component(s) to fix/settle the specific finger U (finger Us) placed thereon.

The height, the width and the length in the depth direction of the finger rest 31 are set for the finger Us to be stably placed, and their specific dimensions are set as appropriate. Since the thickness of fingers U and the height of nails T differ from user to user, the finger rest 31 may be replaceable depending on the user. Further, the finger rest 31 may be replaceable depending on whether printing is performed on the nails T of four fingers other than the thumb of the left/right hand H (HL, HR) or on the nail T of the thumb thereof.

As shown in FIG. 3A, FIG. 3B and FIG. 4, the placement surface 3 is divided in the width direction into a region where the finger rest 31, on which the nail T as the printing target and its finger Us are placed, is positioned and the left and right regions of this finger rest 31, namely, a first area Ar1 as the left region of the finger rest 31 and a second area Ar2 as the right region of the finger rest 31 in FIG. 3A, FIG. 3B and FIG. 4.

In the first area Ar1 and the second area Ar2, fingers Un are placed. The fingers Un are fingers U on the left side and the right side of the finger Us placed on the finger rest 31 and correspond to nails T as a no-printing target(s). As shown in FIG. 3A and FIG. 3B, when printing is performed on the nail T of one of the four fingers of the left/right hand H (HL, HR), the thumb is not placed on the placement surface 3, and may stand by in (be evacuated to) the space under the partition plate 15.

When printing is performed on the nail T of the thumb of the left/right hand H (HL, HR), as shown in FIG. 4, the thumb is placed on the finger rest 31, and the other four fingers are, for example, curled and placed on the side or the like of the thumb.

For example, when the thumb of the left hand HL is placed on the finger rest 31 as the finger Us, as shown in FIG. 4, the four curled (clenched) fingers are placed in the first area Ar1, which is the left region of the finger rest 31. As indicated by a dash-dot-dash line in FIG. 4, the four clenched fingers form a specific part Ph, which is described below, in this embodiment.

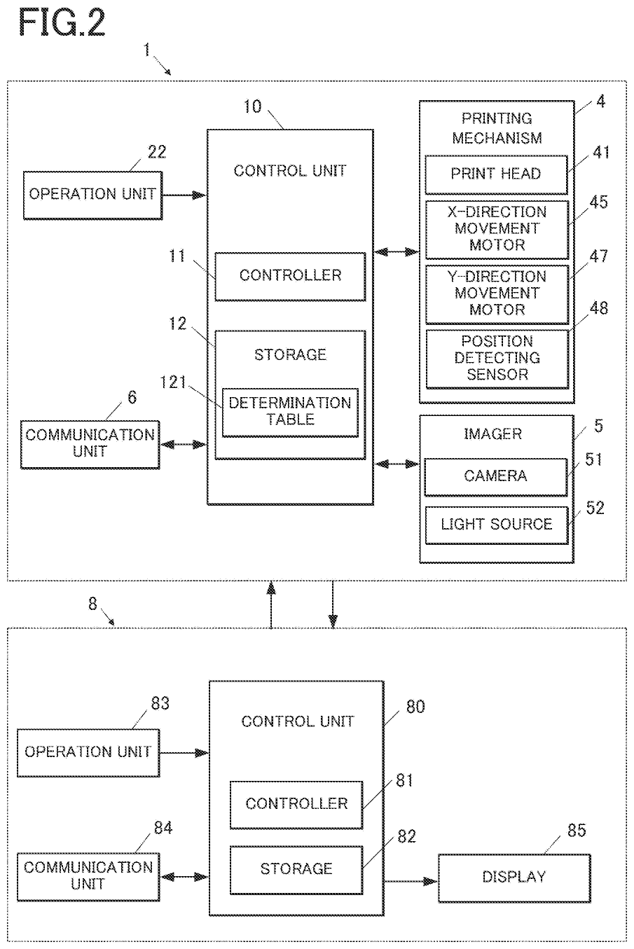

FIG. 2 is a block diagram of the main parts of the printer according to this embodiment and its cooperating terminal device, showing control configurations thereof.

As shown in FIG. 2, the printer 1 includes the aforementioned operation unit 22, a printing mechanism 4, an imager 5, a communication unit 6 and a control unit 10.

The printing mechanism 4 is provided in the case 2 above the partition plate 15, and performs printing on the surface of the nail T as the printing target (printing target surface).

As shown in FIG. 2, the printing mechanism 4 includes a print head 41, an X-direction movement motor 45 and a Y-direction movement motor 47 (shown in FIG. 2).

The print head 41 of this embodiment has a surface (lower surface) that faces a nail surface, the lower surface being configured as an ink discharge surface provided with a plurality of nozzle openings to discharge ink (all not shown), and produces fine droplets of ink and directly sprays (discharges) the ink to the nail surface from the ink discharge surface, thereby performing printing on the nail surface. That is, the print head 41 is an inkjet print head. The ink discharge method or the like is not particularly limited. Further, the print head 41 is not particularly limited in configuration, but may be an ink cartridge-integrated head in which a discharge mechanism, such as the ink discharge surface, and an ink cartridge, where ink is stored, are integrated, for example.

The print head 41 can discharge color inks, such as cyan (C), magenta (M) and yellow (Y) inks. The type and the number of print heads 41 are not particularly limited. For example, in addition to the print head 41 that discharges the abovementioned color inks, a print head for undercoating may be provided to print liquid for undercoating (e.g., white ink, etc.) before a design is printed.

The X-direction movement motor 45 constitutes an X-direction movement mechanism that moves the print head 41 in the left-right direction (X direction) of the printer 1. The Y-direction movement motor 47 constitutes a Y-direction movement mechanism that moves the print head 41 in the front-back direction (Y direction) of the printer 1. The X-direction movement motor 45 and the Y-direction movement motor 47 are, for example, stepping motors, and respectively move the print head 41 in the X direction and the Y direction as appropriate.

The printing mechanism 4 further includes a position detecting sensor 48 that detects (senses) the position of the print head 41. Examples of the position detecting sensor 48 include an origin sensor that detects the origin position of the print head 41 in the X direction and the Y direction and an encoder sensor that grasps a movement state of the print head 41.

The position detecting sensor 48 is not particularly limited in type and configuration.

The imager 5 includes a camera 51 and a light source 52.

The camera 51 is a small-sized imaging device that includes a solid state image sensor having two million pixels or more and a lens.

The camera 51 obtains an image of the hand H including finger(s) U placed on the placement surface 3. More specifically, the camera 51 images almost the entire placement surface 3 centering the finger rest 31, and consequently obtains, for example, an image of the finger Us, the nail T of which is the printing target, placed on the finger rest 31 and the finger(s) Un, the nails T of which are not the printing target, placed in the left region and/or the right region of the finger rest 31 (i.e., first area Ar1 and/or second area Ar2) (an image of a finger(s) U including a nail(s) T), an image of the specific part Ph, and so forth.

In this embodiment, the camera 51 images almost the entire placement surface 3. Hence, the camera 51 to be used has a relatively wide angle of view, capable of imaging a wide area from the left region (first area Ar1) to the right region (second area Ar2) of the finger rest 31 centering the center (centerline CL indicated by a broken line in FIG. 3A, FIG. 3B and FIG. 4) of the finger rest 31, where the finger Us corresponding to the nail T as the printing target is placed. In FIG. 3A, FIG. 3B and FIG. 4, an imaging possible area Arp by the camera 51 of this embodiment is indicated by a broken-line frame.

The light source 52 is an illuminating lamp, such as a white LED.

In this embodiment, the printer 1 obtains data of designs (nail designs) that are printed on nails T and other data via/from external devices. The printer 1 includes the communication unit 6 that transmits and receives information to and from external devices. Examples of the external devices include the abovementioned terminal device 8, which is described below in detail, and various servers.

Communication between the printer 1 and an external device is performed, for example, by a wireless LAN. The communication between the printer 1 and an external device is not limited thereto but may be performed by any system. For example, a network line, such as the Internet, may be used, or wireless communication based on a short-range wireless communication standard, such as Bluetooth® or Wi-Fi, may be performed. This communication is not limited to wireless connection. Hence, the communication unit 6 may be configured to transmit and receive various data to and from external devices by wired connection. The communication unit 6 includes an antenna chip and/or the like compatible with the communication system and communication standard of various external devices that are expected to communicate with the communication unit 6.

The control unit 10 included in the printer 1 is a computer that includes: the controller 11 including at least one processor, such as a not-shown a central processing unit (CPU); and a storage 12 including at least one memory, such as a not-shown read only memory (ROM) and a not-shown random access memory (RAM).

The ROM or the like of the storage 12 stores various programs, various data and so forth to cause the printer 1 to operate.

In particular, in this embodiment, of the storage 12, a nonvolatile memory, which can retain stored data even after power-off, stores data of a determination table 121 (shown in FIG. 5) as information to determine the type (finger type) of the finger Us placed on the finger rest 31, namely, to determine which finger of which hand the finger Us is, the thumb, the index finger, the middle finger, the ring finger or the little finger of the left hand HL or the right hand HR.

The controller 11 loads the various programs stored in the ROM or the like to a working area of the RAM and executes these, thereby controlling operation of the components of the printer 1 in an integrated manner.

That is, the controller 11 performs various functions by working together with the programs (e.g., a printing process application program, a determination process application program for discriminating between fingers, i.e., for determining the type of a finger, etc.) for the printer 1 to perform printing, determination processes of this embodiment, and so forth.

The functions of the controller 11 may be performed by the controller 11 executing the programs (software) or may be performed by a dedicated module(s) (hardware).

In this embodiment, the controller 11 mainly performs the functions of controlling operation of each component of the printing mechanism 4, controlling operation of each component of the imager 5, controlling operation of the communication unit 6, and determining the type of the finger Us from an image(s).

In this embodiment, the controller 11 that performs the function of determining the type of the finger Us and the camera 51 constitute the determiner.

The controller 11 causes the print head 41, the motors (X-direction movement motor 45 and Y-direction movement motor 47) and so forth of the printing mechanism 4 to print a design among various designs (nail designs) on the nail T of the finger Us placed on the finger rest 31 on the placement surface 3, according to print data. The controller 11 receives the print data from an external device, such as the terminal device 8, via the communication unit 6. In this embodiment, a controller 81 of the terminal device 8, which is described below, generates the print data.

The controller 11 controls operation of the camera 51 and operation of the light source 52 of the imager 5, thereby causing the imager to obtain, for example, an image of the hand H including a nail(s) T and a finger(s) U.

In this embodiment, the controller 11 causes the camera 51 to image a wide area, namely, to image not only the finger Us corresponding to the nail T as the printing target but also its surroundings. More specifically, the controller 11 causes the camera 51 to image almost the entire placement surface 3 and consequently obtain, for example, an image of not only the finger Us (finger Us with its nail T visible) placed on the finger rest 31 but also the fingers Un (fingers Un with their nails T visible) placed on the left side and/or the right side of the finger rest 31 or the specific part Ph (shown in FIG. 3A, FIG. 3B and FIG. 4).

The “specific part Ph” refers to a part of the hand H, which includes not only fingers U and nails T but also others. Examples thereof include the back of the hand H, a fist-like part formed of clenched fingers U (e.g., a part enclosed by a dash-dot-dash line with “Ph” in FIG. 4) and the base of a finger(s) U. When the thumb of the left/right hand H is the finger Us corresponding to the nail T as the printing target, unlike the other four fingers (index to little fingers) (shown in FIG. 3A and FIG. 3B), the fingers Un are not placed with their nails T visible on either side of the finger Us (shown in FIG. 4). Hence, the controller 11 cannot determine whether the type of the finger Us is the thumb of the left hand HL or the thumb of the right hand HR on the basis of a placement state of fingers U (Un) on the left side and the right side of the finger Us, the fingers U (Un) being placed thereon with their nails T visible, and hence adopts an effective method of analyzing an image for the specific part Ph that appears, in the image, on the left side, the right side or the like of the finger Us, which is described below.

The determination processes for four fingers (index to little fingers) and for thumbs, which are for determining the type of the finger Us on the basis of the analysis result of an image(s), is described below.

The controller 11 determines the type of the finger Us on the basis of the placement state of fingers U (Un) in an image of the hand H including finger(s) U obtained by the camera 51.

The controller 11 first analyzes the image to detect, from the image, the finger Us placed on the finger rest 31 and the fingers Un placed in the first area Ar1 and the second area Ar2. The controller 11 also analyzes the image to detect the nails T of the fingers U. More specifically, for example, on the basis of color difference between the fingers U and the placement surface 3, the controller 11 analyzes the image to extract the contours of the fingers U (Us, Un) and the contours of the nails T of the fingers U. The method for extracting the contours of the fingers U and the contours of the nails T from the image is not particularly limited. In this stage, detection of the placement of fingers U (and their nails T) is enough. Hence, high-precision detection, such as detection for recognizing the shape of a nail T as a printing region, is unnecessary.

The nail T of the finger Us placed on the finger rest 31 is the printing target. Hence, as to the nail T of the finger Us, the controller 11 may perform high-precision detection for recognizing the nail region (inner region of the nail contour) as the printing region from the image obtained for determining the type of the finger Us. Alternatively, as to the nail T of the finger Us, the controller 11 may obtain an additional image for recognizing the nail region (inner region of the nail contour) and perform a high-precision nail recognition process.

As described above, in this embodiment, the storage 12 or the like stores, as association information, the determination table 121 in which the placement state of fingers U is associated with the type of the finger Us (finger type candidates for the finger Us), and the controller 11 refers to the determination table 121 as needed and determines the type of the finger Us in accordance with the association of the placement state of fingers U with the type of the finger Us.

In this embodiment, as described above, the finger rest 31, where the finger Us corresponding to the nail T as the printing target is placed, is provided, and the controller 11 determines the type of the finger Us in accordance with the number of nails T detected from the fingers U placed on each of the left side and the right side of the finger Us placed on the finger rest 31. Hence, the determination table 121 includes: information on the number of nails T on each of the left side and the right side of the finger Us as the placement of fingers U; and finger type candidates associated therewith.

FIG. 5 shows an example of the determination table.

As shown in FIG. 5, as a result of image analysis, for example, if the fingers Un (numbers of nails T) on the left side and the right side of the finger Us placed on the finger rest 31 are three on the left side and zero on the right side of the finger Us, the finger type candidates for the finger Us are the index finger of the left hand HL and the little finger of the right hand HR. As another example, if the fingers Un (numbers of nails T) on the left side and the right side of the finger Us are two on the left side and one on the right side of the finger Us, the finger type candidates for the finger Us are the middle finger of the left hand HL and the ring finger of the right hand HR.

If no finger U (Un) is on either side of the finger Us, it is determined that the finger Us is the thumb of the left hand HL or the thumb of the right hand HR. Fingers U with their nails T invisible (fingers U clenched like a first) as shown in FIG. 4 are not recognized as fingers in the determination processes, which are performed by the controller 11. That is, in the example shown in FIG. 4, the fingers Un (numbers of nails T) on the left side and the right side of the finger Us are both zero. The fist-like part formed of the clenched fingers U or the back of the hand H is treated as the specific part Ph, which is described below.

If the finger Us is one of the four fingers, which are the index to little fingers, the controller 11 narrows down the finger type candidates for the finger Us by referring to the determination table 121. Then, the controller 11 derives the areas of nails T of fingers U in an image.

More specifically, the controller 11 derives the areas of the nail regions (inner regions of the contours of the nails T) regarding the nails T of the fingers U positioned at the left end and the right end among the four fingers U in an image.

Upon deriving the areas of the nails T, the controller 11 compares the area of the nail T of the leftmost finger U with the area of the nail T of the rightmost finger U, and determines the finger U the nail T of which has a smaller area as the little finger.

In the example shown in FIG. 3A, the numbers of nails T of the fingers Un on the left side and the right side of the finger Us are two on the left side and one on the right side of the finger Us, and the nail T of the leftmost finger U is smaller than the nail T of the rightmost finger U. It is therefore determined that the finger Us placed on the finger rest 31 is the middle finger of the left hand HL.

In the example shown in FIG. 3B, the numbers of nails T of the fingers Un on the left side and the right side of the finger Us are two on the left side and one on the right side of the finger Us as in the example shown in FIG. 3A, but the nail T of the rightmost finger U is smaller than the nail T of the leftmost finger U. It is therefore determined that the finger Us placed on the finger rest 31 is the ring finger of the right hand HR.

If no finger U with its nail T visible is on either side of the finger Us, and it is therefore determined that the finger Us is the thumb of the left hand HL or the thumb of the right hand HR, the controller 11 further determines which hand H has been imaged, the left hand HL or the right hand HR, on the basis of a positional relationship between the specific part Ph and the finger U (Us) of the hand H in the image.

For example, as shown in FIG. 4, if the specific part Ph, such as the back of the hand H or the fist-like part, is detected on the left side of the finger Us placed on the finger rest 31, the controller 11 determines that the finger Us is the thumb of the left hand HL.

The base on which an object is recognized as a finger U or the specific part Ph is not limited to whether the object has a nail T visible in an image. For example, a shape unique to fingers U (e.g., a long and narrow shape) and the shape of the back of the hand H, a first or the like (e.g., a shape having some width to form a mass) may be stored in the storage 12 or the like as shape patterns, and the controller 11 may determine whether an object in an image is a finger U or the specific part Ph by determining to which shape pattern a shape detected from the image is closer. Alternatively, the shape of a first or the like of the user may be stored in the storage 12 or the like by the camera 51 imaging the first or the like in advance, and the controller 11 may determine whether an object in an image is a finger U or the specific part Ph by pattern matching or the like with the stored shape image.

The method for determining whether the specific part Ph is on the left side or the right side of the finger Us placed on the finger rest 31 is not particularly limited.

For example, a general image recognition process may be performed to determine whether some sort of object is positioned on the left side or the right side of the finger Us. Alternatively, the following process may be performed: in advance, setting, on both sides of the finger rest 31, regions where the specific part Ph, such as the back of the hand H or the fist-like part, could be present, and coloring the regions in a single color (e.g., green) easily distinguishable from the color of skin; and then, from an image obtained by the camera 51, calculating the area of or the number of pixels in each of regions of the single color in the preset regions (i.e., first area Ar1 and second area Ar2), and determining that the specific part Ph, such as the back of the hand H or the fist-like part, is on the left side of the finger rest 31 if the region of the single color is less in the first area Ar1, or determining that the specific part Ph, such as the back of the hand H or the fist-like part, is on the right side of the finger rest 31 if the region of the single color is less in the second area Ar2.

As described above, the printer 1 of this embodiment performs printing on nails T in cooperation with the terminal device 8.

The terminal device 8 is, for example, a portable terminal device, such as a smartphone, but not limited thereto. Examples thereof include a tablet personal computer (PC), a laptop PC, a stationary PC, and a terminal device for gaming.

As shown in FIG. 2, the terminal device 8 includes the abovementioned operation unit 83, a communication unit 84, a display 85 and a control unit 80.

The operation unit 83 is configured to make/do various inputs/settings or the like in response to user operations, and is, for example, a touchscreen integrated with the surface of the display 85. When a user operates the operation unit 83, an input signal corresponding to the operation is transmitted to the controller 81 of the control unit 80.

The touchscreen configured on/by the display 85 displays various operation screens under the control of the controller 81, and the user can make operations for various inputs/settings or the like by touching the touchscreen. The operation unit 83 for various inputs/settings or the like is not limited to the touchscreen.

In this embodiment, by the user operating the operation unit 83, the terminal device 8 outputs various instructions, such as an instruction to start printing, to the printer 1. Thus, the terminal device 8 can function as an operation unit for the printer 1.

Further, by the user operating the operation unit 83, a nail design (design) to be printed on a nail T can be selected, for example.

The communication unit 84 is configured to communicate with the communication unit 6 of the printer 1.

Communication between the printer 1 and the terminal device 8 can be performed by either a wireless connection system or a wired connection system. The communication system is not particularly limited. The communication unit 84 can be any communication unit as far as it can communicate with the printer 1, and therefore is compatible with the communication standard of the communication unit 6 of the printer 1.

The display 85 is configured, for example, by a liquid crystal display (LCD), an organic electroluminescent display, another flat display, or the like.

As described above, a touchscreen for various inputs may be integrated with the surface of the display 85. In this case, the touchscreen functions as the operation unit 83.

In this embodiment, the display 85 can display nail designs input/selected by the user with the operation unit 83, various guidance screens, warning display screens, various images obtained by the camera 51 of the printer 1, and so forth.

As shown in FIG. 3A, FIG. 3B and FIG. 4, in this embodiment, the image that is obtained to determine the type of the finger Us is obtained by imaging a wide area of the placement surface 3.

When an image of the finger Us and/or the like is displayed on/by the display 85, the image obtained by imaging almost the entire placement surface 3 may be displayed as it is, or an image of the finger rest 31, where the finger Us corresponding to the nail T as the printing target is placed, and its surroundings may be cut out from the image of the substantially entire placement surface 3 and displayed.

Further, the display 85 of this embodiment functions as an informing unit that informs the user of the result of the determination (determination result) made by the controller 11 of the printer 1.

That is, when the controller 11 determines the type of the finger Us placed on the finger rest 31, the display 85 displays the determination result on the display screen to inform the user of the determination result. This enables the user to check whether the nail T of the finger U on which printing is about to be performed is the nail T of the finger U of the type intended by the user, thereby avoiding printing of a design on the nail T of an unintended finger U by mistake.

The contents displayed on the display 85 are not limited to those mentioned above.

As shown in FIG. 2, the control unit 80 of the terminal device 8 of this embodiment is a computer that includes: the controller 81 including a processor, such as a not-shown central processing unit (CPU); and a storage 82 including a not-shown read only memory (ROM) and a not-shown random access memory (RAM).

The storage 82 stores various programs, various data and so forth to cause the terminal device 8 to operate.

More specifically, the ROM or the like of this embodiment stores various programs, such as an operating program to control the components of the terminal device 8 in an integrated manner and a nail printing application program to perform nail printing with the printer 1. The controller 81 loads these programs, for example, to a working area of the RAM and executes these, thereby controlling the components of the terminal device 8 in an integrated manner.

The storage 82 of this embodiment stores data of nail designs (designs).

The nail designs (designs) stored in the storage 82 may be existing designs prepared in advance or designs created by the user himself/herself. If the terminal device 8 is connectable to various networks, the terminal device 8 may be able to import nail designs (designs) stored in not-shown server devices or the like to which the terminal device 8 is connectable.

The controller 81 of the terminal device 8 performs the functions of controlling operation of the communication unit 84, controlling operation of the display 85, and so forth. These functions are performed by the CPU of the controller 81 and the programs stored in the ROM of the storage 82 working together. The functions that the controller 81 of the terminal device 8 performs are not limited to these, but may perform various functions.

For example, the controller 81 may generate print data that is printed by the printer 1. If the controller 81 generates print data, the printer 1 transmits an image(s) obtained by the camera 51 of the imager 5, such as an image of the finger Us including its nail T, and various pieces of information on the nail T as the printing target, such as the nail contour recognized from the image, to the terminal device 8.

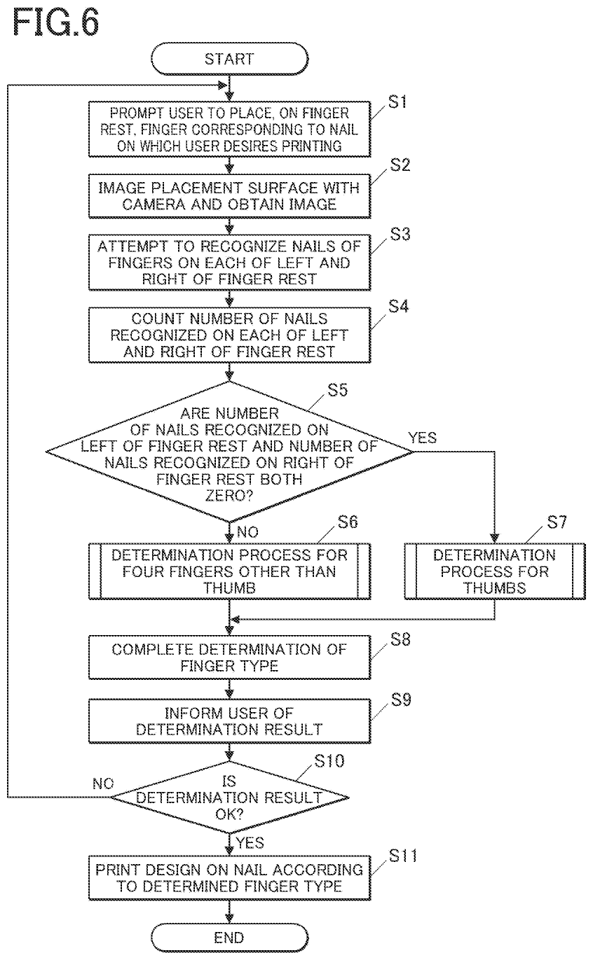

Next, with reference to FIG. 6 through FIG. 8, the determination method of this embodiment will be described.

FIG. 6 is a flowchart showing the overall flow of a printing control process including the abovementioned determination processes of this embodiment.

When a printing process (nail printing process) is performed by using the printer 1 of this embodiment, a user first powers up the printer 1 and its cooperating terminal device 8.

When the printer 1 and the terminal device 8 are started up, a message or the like is displayed on the display 85 or the like of the terminal device 8, prompting the user to place, on the finger rest 31, the finger Us corresponding to the nail T on which the user desires printing (Step S1).

Following the message, when the user places, on the finger rest 31, the finger Us corresponding to the nail T on which the user desires printing, and places, on the left side and/or the right side of the finger rest 31 on the placement surface 3, the other fingers Un of the hand H (left hand HL or right hand HR) having the finger Us (shown in FIG. 3A and FIG. 3B), the controller 11 controls the imager 5, thereby causing the camera 51 to image the placement surface 3, and obtains an image of the fingers U placed on the placement surface 3 obtained by the camera 51 (Step S2).

The controller 11 then attempts to recognize (detect) the nails T of the fingers Un placed on each of the left side and the right side of the finger rest 31 from the obtained image (Step S3), and counts the number of nails T recognized on each of the left side and the right side of the finger rest 31 (Step S4).

The controller 11 determines whether the number of nails T recognized on the left side of the finger rest 31 and the number of nails T recognized on the right side of the finger rest 31 are both zero (Step S5). If the controller 11 determines that the number of nails T recognized on at least one of the left side and the right side of the finger rest 31 is not zero (Step S5; NO), the controller 11 determines that the finger Us placed on the finger rest 31 is one of the four fingers other than the thumb, and performs the determination process for the four fingers (i.e., index to little fingers) other than the thumb (Step S6).

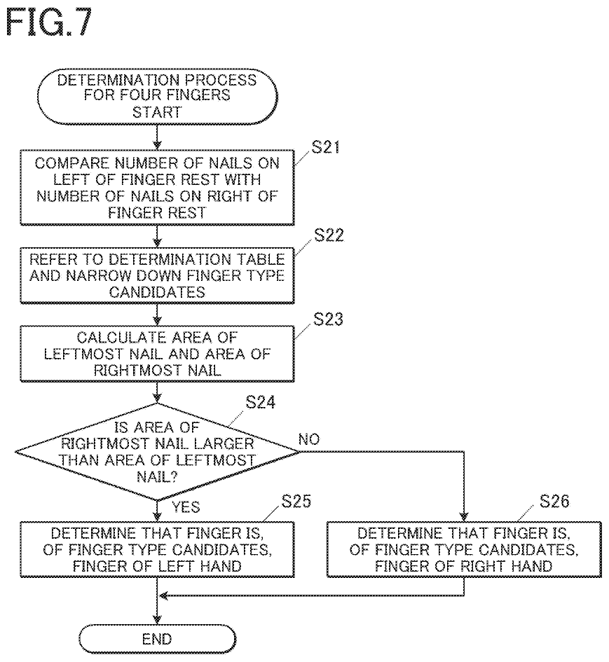

FIG. 7 is a flowchart showing details of the determination process for the four fingers other than the thumb (Step S6 in FIG. 6).

As shown in FIG. 7, in the determination process for the four fingers, the controller 11 first compares the number of nails T on the left side of the finger rest 31 with the number of nails T on the right side of the finger rest 31 (Step S21). That is, the controller 11 compares the number of nails T in the left region (first area Ar1 in FIG. 3A and FIG. 3B) of the finger rest 31 with the number of nails T in the right region (second area Ar2 in FIG. 3A and FIG. 3B) of the finger rest 31. The number of nails T in each of the first area Ar1 and the second area Ar2 is detected in Step S4 in FIG. 6. Then, the controller 11 reads the determination table 121 from the storage 12 and refers thereto, and narrows down the finger type candidates (Step S22).

For example, if the number of nails T in the first area Ar1 is two and the number of nails T in the second area Ar2 is one, the controller 11 narrows down the finger type candidates for the finger Us to the middle finger of the left hand and the ring finger of the right hand, according to the determination table 121.

Further, the controller 11 calculates the area of the leftmost nail T and the area of the rightmost nail T among the four fingers U on the placement surface 3 (Step S23) and compares these two areas with one another.

The controller 11 determines whether the area of the rightmost nail T is larger than the area of the leftmost nail T (Step S24). If the controller 11 determines that the area of the rightmost nail T is larger than the area of the leftmost nail T (Step S24; YES), it means that the little finger is at the left end, and accordingly the controller 11 determines that the finger Us placed on the finger rest 31 is a finger of the left hand HL. That is, in the abovementioned example in which the number of nails T in the first area Ar1 is two and the number of nails T in the second area Ar2 is one, the controller 11 determines that the finger Us is the middle finger of the left hand HL (Step S25). In Step S24, if the controller 11 determines that the area of the rightmost nail T is smaller than the area of the leftmost nail T (Step S24; NO), the controller 11 determines that the finger Us placed on the finger rest 31 is a finger of the right hand HR. That is, in the abovementioned example in which the number of nails T in the first area Ar1 is two and the number of nails T in the second area Ar2 is one, the controller 11 determines that the finger Us is the ring finger of the right hand HR (Step S26).

Returning to FIG. 6, if the controller 11 determines that the number of nails T recognized on the left side of the finger rest 31 and the number of nails T recognized on the right side of the finger rest 31 are both zero (Step S5; YES), the controller 11 determines that the finger Us placed on the finger rest 31 is the thumb of the left hand HL or the thumb of the right hand HR, and performs the determination process for thumbs (Step S7).

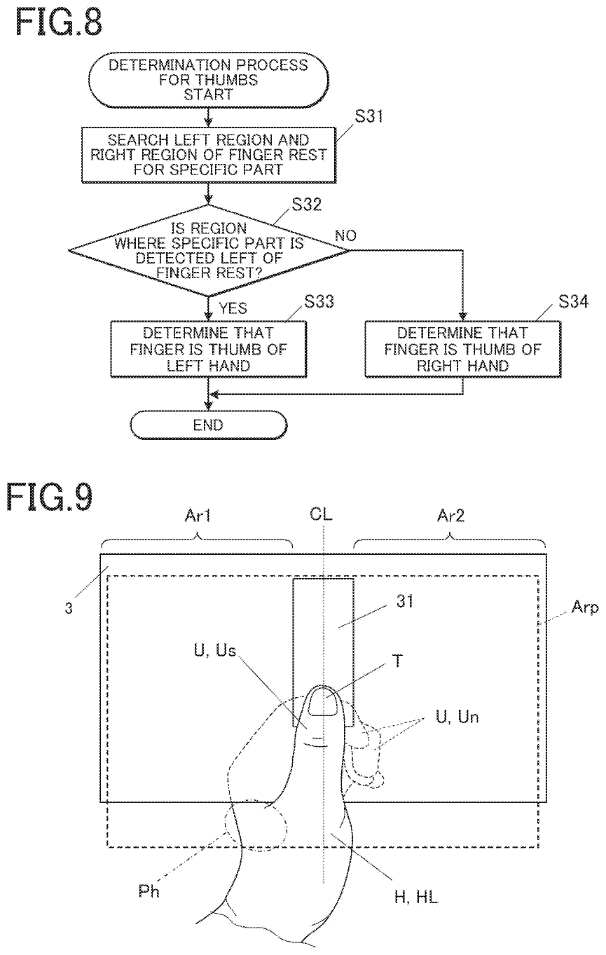

FIG. 8 is a flowchart showing details of the determination process for thumbs (Step S7 in FIG. 6).

As shown in FIG. 8, in the determination process for thumbs, the controller 11 searches the left region and the right region (i.e., first area Ar1 and second area Ar2) of the finger rest 31 for the specific part Ph (Step S31).

The controller 11 determines whether, in the image, the region where the specific part Ph is detected is the first area Ar1 on the left side of the finger rest 31 (Step S32). For example, as shown in FIG. 4, if the specific part Ph is in the first area Ar1 on the left side of the finger rest 31 (Step S32; YES), the controller 11 determines that the finger Us placed on the finger rest 31 is the thumb of the left hand HL (Step S33).

If the specific part Ph is not in the first area Ar1 on the left side of the finger rest 31 (Step S32; NO), the controller 11 determines that the finger Us placed on the finger rest 31 is the thumb of the right hand HR (Step S34).

Returning to FIG. 6, when completing determination of the type of the finger Us placed on the finger rest 31 (Step S8), the controller 11 performs control to inform the user of the determination result (Step S9). How to inform the user of the determination result is not particularly limited, but, in this embodiment, the determination result is transmitted to the cooperating terminal device 8 via the communication unit 6 to be displayed on the display 85 or the like of the terminal device 8.

The controller 11 determines whether the user approves the determination result (Step S10). If the user approves the determination result by making an input operation indicating that the determination result is OK with the operation unit 83 or the like of the terminal device 8, for example, by operating an OK button or the like (Step S10; YES), the terminal device 8 outputs the input operation to the printer 1, and the controller 11 controls operation (printing operation) of the printing mechanism 4, thereby causing the printing mechanism 4 to print a design (nail design) on the nail T according to the determined finger type (Step S11).

If the user does not approve the determination result (Step S10; NO), the printing control process returns to Step S1, and Step S1 and the following steps are repeated. In this case, a message or the like may be displayed on the display 85 or the like of the terminal device 8, prompting the user to check and place, on the finger rest 31, a finger U corresponding to the nail T on which the user desires printing.

If designs are successively printed on the nails T of two or more fingers U, a message is displayed on the display 85 or the like of terminal device 8 when the process of printing a design on the nail T of a finger U (Step S11) is completed, prompting the user to place, on the finger rest 31, a finger U corresponding to the nail T on which the user desires printing next, and Step S2 in FIG. 6 and the following steps are repeated.

Thus, the printer 1 including the determiner as in this embodiment can print user's desired designs on the nails of his/her fingers U, without giving the user a trouble of checking the finger Us placed on the finger rest 31 and a trouble of inputting a correct finger type.

As described above, the printer 1 of this embodiment includes the determiner including the controller 11 that obtains an image of the hand H including at least the finger Us (first finger) placed on the placement surface 3, the image being obtained by the camera 51, and determines the type of the finger Us based on the placement state of the fingers U (Un) (second fingers) recognized as fingers in the image.

This makes it possible, in the case of printing a design (nail design) on a nail T, to automatically determine on which finger's nail T printing is about to be performed by reading, from an image, the placement state of fingers U (Un) placed on the placement surface 3 and recognized as fingers, without giving the user a trouble of inputting, by himself/herself, a finger type corresponding to the nail T on which the user desires printing (i.e., printing target).

Since printing is performed on the basis of the determination result, it is possible to print a user's preferred design on the finger (nail) on which the user desires printing, without giving the user a trouble of inputting, in advance, on which finger's nail T printing should be performed.

Further, for example, even if the user mistakenly places, on the finger rest 31, a finger U unfit for a design that the user sets in advance, printing in such a wrong state can be prevented.

Further, since the determiner is configured by the camera 51 and the controller 11, which are components that the printer 1 originally includes, the determiner excellent in user-friendless can be easily and simply configured without additional components, such as various sensors, provided.

Further, in this embodiment, the storage 12 in which the placement state of the fingers U (Un) is associated and stored with the type of the finger Us (in this embodiment, the determination table 121 shown in FIG. 5) is provided, and the controller 11 determines the type of the finger Us in accordance with the association of the placement state of the fingers U (Un) with the type of the finger Us stored in the storage 12.

This makes it possible to easily determine the finger type (narrow down the finger type candidates) by referring to the association information (e.g., the determination table 121) stored in the storage 12 or the like.

Further, in this embodiment, the finger rest 31, on which the finger Us is placed, is provided, and the controller 11 determines the type of the finger Us in accordance with the number of the fingers Un recognized on each of the left side and the right side of the finger Us placed on the finger rest 31.

Thus, if information as the placement state of fingers U (Un) required for determining the type of the finger Us is the number of fingers U (Un) recognized as fingers on each of the left side and the right side of the finger Us, the information as the placement state of fingers U (Un) can be easily obtained from an image obtained by imaging the placement surface 3. Since the user only needs to place his/her hand H on the placement surface 3, the finger type can be easily determined without any complicated work.

Further, the controller 11 of this embodiment derives the areas of nails T of fingers U among the finger Us and the fingers Un, and determines the type of the finger Us based on the derived areas of the nails T.

The areas of the nails T of fingers U have general characteristics that apply to any user. For example, among the nails T of the fingers U of the hand H, the nail T of the little finger is the smallest, and the nail T of the thumb is the largest. The areas of the nails T that are derivable from an image can be used for determining the type of the finger Us. Thus, general information can be used for determining the finger type and easily obtained.

Further, in this embodiment, the specific part Ph of the hand H could be included in an image obtained by the camera 51. In such a case, the controller 11 determines whether the hand H imaged is the left hand or the right hand based on the positional relationship between the finger Us and the specific part Ph of the hand H in the image.

Unlike the other four fingers, when printing is performed on the nail T of the thumb of the hand H, it is difficult to align the thumb with the centerline CL of the placement surface 3 with all the other fingers spread and placed on the placement surface 3.

In this regard, in this embodiment, an image of the substantially whole hand H is obtained, and the type of the finger Us is determined based on the specific part Ph of the hand H in the image. This makes it possible to properly determine the type of the finger Us even when the fingers U (Un) are in the abovementioned special placement state.

Further, if the informing unit that informs the user of the result of the determination made by the controller 11 is provided, it is possible to request the user to check whether the nail T on which printing is about to be performed is the nail T of the finger U intended by the user.

This can prevent a design (nail design) from being printed on the nail T of an unintended finger U without the user noticing that a wrong finger U is set on the finger rest 31 by mistake.

In this embodiment, the display 85 of the terminal device 8 functions as the informing unit, but the informing unit is not limited thereto. The printer 1 may include a display, and this display may function as the informing unit. Alternatively or additionally, the printer 1 or the like may include an audio output unit (e.g., a speaker) and cause the audio output unit to output a message by audio, informing the user of the determination result. It is not essential to inform the user of the determination result. Hence, the printing control process may proceed without informing the user of the determination result. If the user inputs in advance a finger type corresponding to the nail T on which the user desires printing, the user may be informed, as an alert, only when the finger Us of the finger type that is different from the input finger type is placed on the finger rest 31.

Although one or more embodiments of the present disclosure have been described above, it goes without saying that the present disclosure is not limited to the embodiments above, but can be modified in various respects without departing from the scope of the present disclosure.

For example, in the above embodiment, if the finger Us corresponding to the nail T as the printing target is the thumb of the hand H, the fist-like part formed of the other four fingers clenched is detected as the specific part Ph of the hand H and it is determined whether the finger Us is the thumb of the left hand HL or the thumb of the right hand HR (shown in FIG. 4). However, the specific part Ph is not limited to the part shown in FIG. 4.

For example, as shown in FIG. 9, when the thumb of the hand H is the finger Us corresponding to the nail T as the printing target, the thumb is placed on the finger rest 31, where the finger Us is placed, and the other fingers Un may be evacuated to the space under the partition plate 15. In this case, the partition plate 15 can be grabbed by the thumb and the other four fingers. This stabilizes the thumb placed on the finger rest 31. In addition, the thumb can be placed on the finger rest 31 so as to be aligned with the centerline CL in a natural posture. This enables high-precision nail recognition.

In the example shown in FIG. 9, the specific part Ph, which is for determining whether the finger Us is the thumb of the left hand HL or the thumb of the right hand HR, is near the base of the thumb as indicated by a dash-dot-dash line. Hence, it is determined that the specific part Ph is, between the left side and the right side of the centerline CL in an image, on the side where the hand H protrudes more (e.g., the side where the contour of the hand H is farther) from the centerline CL when the hand H on the left side and the hand H on the right side of the centerline CL are compared with one another.

The base of the finger U (Us) and its vicinity are highly likely to be off the placement surface 3 (e.g., under the placement surface 3 in FIG. 9). In order to detect such a part as the specific part Ph, the camera 51 to be used has a wide imaging possible area Arp as indicated by a broken-line frame in FIG. 9.

Further, if, as shown in FIG. 9, printing is performed on the nail T of the thumb of the hand H as the finger Us with the partition plate 15 grabbed by the thumb and the other four fingers, the thumb may be placed directly on the placement surface 3. This also stabilizes the finger Us.

Thus, as a place where the finger Us is placed, the finger rest 31 having a height may not be provided. For example, a place where the finger Us is placed may be configured by a groove, a bump, a dent or the like detectable by a touch with a fingertip. Alternatively, the centerline CL may be a grooved line, a ridgy line or the like, and a certain area along the centerline CL may be used as a place where the finger Us is placed.

Further, in the above embodiment, the storage 12 or the like stores the determination table 121, and the controller 11 refers to the determination table 121 and narrows down the finger type candidates for the finger Us placed on the finger rest 31. However, it is not essential to refer to the determination table 121 to determine the type of the finger Us.

For example, an image(s) of the fingers U of both hands of the user may be preregistered, and the controller 11 may compare an image obtained by imaging the substantially entire placement surface 3 with the preregistered image(s) to determine which finger is placed where.

Further, in the above embodiment, the printer 1 performs printing on nails in cooperation with the terminal device 8, but not limited thereto. The printer 1 may complete printing by itself.

For example, in the above embodiment, input of an instruction to start printing, selection of a design (nail design) and so forth are made with the operation unit 83 of the terminal device 8, but various inputs and so forth may be made with the operation unit 22 of the printer 1. In this case, the printer 1 may include a touchscreen as the operation unit 22. The printer 1 may further include a display. In this case, the touchscreen may be integrated with the display.

If the printer 1 includes a display, the display of the printer 1 may function as the informing unit that informs the user of the determination result about the finger type.

Further, in the above embodiment, data of designs (nail designs) is stored in the storage 82 of the terminal device 8, but not limited thereto. Data of nail designs may be stored in the storage 12 of the printer 1.

Alternatively or additionally, image data of nail designs may be stored in a server device or the like to which the terminal device 8 or the printer 1 is connectable via a network line or the like, and referenced by the user accessing the server device or the like with the terminal device 8 or the printer 1.

This makes it possible to select a nail design to be printed from a larger number of designs without increasing the capacity of the storage 82 or the like.

In the above embodiment, the controller 11 of the printer 1 performs the determination processes and constitutes (part of) the determiner. However, the component that performs the determination processes and constitutes the determiner is not limited to the controller 11 of the printer 1.

For example, a controller of an external device, such as the controller 81 of the terminal device 8, may perform the determination processes. In this case, the printer 1 transmits, via the communication unit 6 or the like, an image of the hand H including finger(s) U obtained by the camera 51 to an external device, such as the terminal device 8, so that the controller 81 or the like can obtain the image.

If the controller 81 of the terminal device 8 performs the determination processes, the application program for the determination processes is stored in the storage 82 or the like of the terminal device 8.

Further, in the above embodiment, the terminal device 8 as an external device obtains an image of a finger(s) U including a nail(s) T from the printer 1, and the controller 81 of the terminal device 8 generates print data. However, the controller 11 of the printer 1 may generate print data. In this case, the printer 1 does not need to exchange data with an external device and accordingly can perform nail printing by itself, without cooperating with an external device. Further, in the above embodiment, the controller 11 of the printer 1 obtains (generates) nail information, such as nail contours defining nail regions, from an image of a finger(s) U including a nail(s) T. However, the controller 81 of the terminal device 8 may obtain (generate) the nail information.

Although some embodiments or the like of the present disclosure have been described above, the scope of the present disclosure is not limited to the embodiments described above, but includes the scope of the present disclosure stated in claims and its equivalents.

What is claimed is:

1. A determiner comprising:
a memory where a program is stored; and
at least one processor that executes the program stored in the memory, wherein the processor
obtains an image of a hand including at least a first finger placed on a placement surface, and
determines a type of the first finger based on a placement state of second fingers recognized as fingers in the image.

2. The determiner according to claim 1,
wherein the placement state of the second fingers is associated and stored with the type of the first finger in the memory, and
wherein the processor determines the type of the first finger in accordance with the association of the placement state of the second fingers with the type of the first finger stored in the memory.

3. The determiner according to claim 2,
wherein the placement surface is provided with a finger rest on which the first finger is placed, and
wherein the processor determines the type of the first finger placed on the finger rest.

4. The determiner according to claim 3, wherein the processor determines the type of the first finger in accordance with the number of the second fingers, in the image, on each of a left side and a right side of the first finger placed on the finger rest.

5. The determiner according to claim 1, the processor derives areas of nails of fingers among the first finger and the second fingers, and determines the type of the first finger based on the derived areas of the nails.

6. The determiner according to claim 1,
wherein a specific part of the hand is included in the image, and
wherein the processor determines whether the hand imaged is a left hand or a right hand based on a positional relationship between the specific part and the first finger of the hand in the image.

7. The determiner according to claim 1, further comprising a display that informs a user of a result of the determination made by the processor.

8. A printer comprising:
the determiner according to claim 1; and
a print head that performs printing based on a result of the determination made by the determiner.

9. A determination method comprising:
obtaining an image of a hand including at least a first finger placed on a placement surface; and
determining a type of the first finger based on a placement state of second fingers recognized as fingers in the image.

10. The determination method according to claim 9,
wherein the placement state of the second fingers is associated and stored with the type of the first finger in the memory, and
wherein the determining includes determining the type of the first finger in accordance with the association of the placement state of the second fingers with the type of the first finger stored in the memory.

11. The determination method according to claim 10,
wherein the placement surface is provided with a finger rest on which the first finger is placed, and
wherein the determining includes determining the type of the first finger placed on the finger rest.

12. The determination method according to claim 11, wherein the determining includes determining the type of the first finger in accordance with the number of the second fingers, in the image, on each of a left side and a right side of the first finger placed on the finger rest.

13. The determination method according to claim 9, wherein the determining includes deriving areas of nails of fingers among the first finger and the second fingers, and determining the type of the first finger based on the derived areas of the nails.

14. The determination method according to claim 9,
wherein a specific part of the hand is included in the image, and
wherein the determining includes determining whether the hand imaged is a left hand or a right hand based on a positional relationship between the specific part and the first finger of the hand in the image.

15. A non-transitory computer-readable storage medium storing a program that causes a computer to:
obtain an image of a hand including at least a first finger placed on a placement surface; and
determine a type of the first finger based on a placement state of second fingers recognized as fingers in the image.
